(19) United States
(12) Patent Application Publication
(10) Pub. No.: US 2026/0063377 A1
(43) Pub. Date: Mar. 5, 2026

(54) CARBON DIOXIDE PHASE CHANGE ENERGY STORAGE AND RELEASE METHOD AND SYSTEM

(71) Applicant: Exax Energy Technology (Shenzhen) Co., Ltd, Shenzhen (CN)

(72) Inventors: Hongtao Zheng, Shenzhen (CN); Wenping Zhang, Shenzhen (CN); Guolei Wang, Shenzhen (CN)

(21) Appl. No.: 19/310,946

(22) Filed: Aug. 27, 2025

(30) Foreign Application Priority Data
Aug. 29, 2024 (CN) 202411198426.2

(51) Int. Cl. F28D 20/02; F25J 3/02

(52) U.S. Cl. CPC F28D 20/028; F25J 3/0266; F25J 2220/80

(57) ABSTRACT

A carbon dioxide phase change energy storage and release method and system are provided. The method includes an energy storage step, and the energy storage step includes a condensation stage. The condensation stage includes a liquid-phase carbon dioxide purification process. In the condensation stage, gas-phase carbon dioxide is converted into liquid-phase carbon dioxide by a first phase change converter, when a stored liquid level of the liquid-phase carbon dioxide reaches a set liquid level, the liquid-phase carbon dioxide purification process is performed to remove impurity liquid from the liquid-phase carbon dioxide. Therefore, the impurity liquid in the liquid carbon dioxide can be purified in a targeted manner through the liquid-phase carbon dioxide purification process, thereby achieving precise impurity removal of precise objects, eliminating adverse effects of the impurity liquid on liquefaction temperature change of the system and corrosion of various equipment pipelines, and making the system more perfect and optimized.

### CROSS-REFERENCE TO RELATED APPLICATION

This application claims priority to Chinese Patent Application No. 202411198426.2, filed on Aug. 29, 2024, which is herein incorporated by reference in its entirety.

### TECHNICAL FIELD

The disclosure relates to the field of phase change energy storage and release technologies, and more particularly to a carbon dioxide phase change energy storage and release method and system.

### BACKGROUND

In construction of energy storage systems for new power energy structures, a physical compression energy storage technology of gas-liquid two-phase carbon dioxide has outstanding advantages such as simple process, mature equipment, high safety and reliability, and high energy utilization efficiency. It is widely recognized in the professional and technical field. Therefore, the construction of gas-liquid two-phase carbon dioxide energy storage and release system presents significant latecomer advantages.

In the gas-liquid two-phase carbon dioxide energy storage and release system, carbon dioxide is used as a working fluid to undergo a closed cycle phase change in the system. The general working fluid cycle process is gas-phase low-pressure storage, gas-phase compression, heat exchange cooling, phase change liquefaction, liquid-phase storage, phase change vaporization, heat exchange heating, and expansion work. As a circulating working fluid, carbon dioxide gas has relatively stable chemical properties, is safe and non-toxic, and is easy to undergo gas-liquid phase change. The gas density is large, which is conducive to process cycles and turbine expansion work.

However, the existing gas-liquid two-phase carbon dioxide energy storage and release system has no targeted design plan for the purity of carbon dioxide, and the energy storage and release process and system cannot be further improved and optimized. During long-term cyclic operation, impurities generated by mechanical wear and lubrication will enter the carbon dioxide working fluid, and thus cannot eliminate adverse effects of impurities enriched in carbon dioxide on the system.

### SUMMARY

An objective of embodiments of the disclosure are to provide a carbon dioxide phase change energy storage and release method and system to solve a technical problem that an existing carbon dioxide phase change energy storage and release system has adverse effects on the system due to accumulation of impurities during operation.

In order to achieve the above objective, technical solutions adopted by the disclosure are as follows.

A carbon dioxide phase change energy storage and release method is provided, the energy storage and release method includes an energy storage step, and the energy storage step includes a condensation stage. The condensation stage includes a liquid-phase carbon dioxide purification process. In the condensation stage, purified high-pressure gas-phase carbon dioxide is converted into liquid-phase carbon dioxide by a first phase change converter, when a stored liquid level of the liquid-phase carbon dioxide reaches a set liquid level, the liquid-phase carbon dioxide purification process is performed to remove impurity liquid from the liquid-phase carbon dioxide according to the liquid-phase carbon dioxide purification process.

In some embodiments, the liquid-phase carbon dioxide purification process includes:
determining that the stored liquid level of the liquid-phase carbon dioxide is consistent with the set liquid level; where, when the stored liquid level of the liquid-phase carbon dioxide is consistent with the set liquid level, the impurity liquid is concentrated at a bottom of the liquid-phase carbon dioxide;
opening an impurity liquid discharge pipeline to discharge the impurity liquid, obtaining a temperature of the impurity liquid discharge pipeline in real-time, and determining whether the temperature is within a preset threshold range; and
in response to the temperature being within the preset threshold range, keeping the impurity liquid discharge pipeline open; otherwise, closing the impurity liquid discharge pipeline.

In some embodiments, the determining that the stored liquid level of the liquid-phase carbon dioxide is consistent with the set liquid level includes:
in response to a liquid level sensor being triggered by the liquid-phase carbon dioxide, determining that the stored liquid level of the liquid-phase carbon dioxide consistent with the set liquid level, to thereby generate liquid level determination information.

The opening an impurity liquid discharge pipeline to discharge the impurity liquid includes:
obtaining, by a controller, the liquid level determination information, and controlling, by the controller and according to the liquid level determination information, a valve on the impurity liquid discharge pipeline to open, to thereby open the impurity liquid discharge pipeline.

In some embodiments, the obtaining a temperature of the impurity liquid discharge pipeline in real-time, and determining whether the temperature is within a preset threshold range includes:
collecting, by a temperature sensor, the temperature in real-time;
obtaining, by the controller, the temperature collected by the temperature sensor in real-time, and comparing the temperature to the preset threshold range; and
in response to the temperature being within the preset threshold range, obtaining a first comparison result, and controlling, by the controller and according to the first comparison result, the valve to keep open; otherwise, obtaining a second comparison result, and controlling, by the controller and according to the second comparison result, the valve to close.

In some embodiments, the impurity liquid at least includes water liquid, and the water liquid includes at least one of free water and dissolved water.

In some embodiments, the energy storage and release method further includes an energy release step, and the energy release step includes a vaporization stage. The energy storage and release method further includes a gas-phase carbon dioxide purification process. The energy storage and release method includes:
in the vaporization stage, converting, by a second phase change converter, the liquid-phase carbon dioxide obtained through the liquid-phase carbon dioxide purification process into low-pressure gas-phase carbon dioxide; and
after the vaporization stage and before the condensation stage, performing the gas-phase carbon dioxide purification process to remove impurities from high-pressure gas-phase carbon dioxide; wherein types of the impurities are one or more.

In some embodiments, the types of the impurities are more. The after the vaporization stage and before the condensation stage, performing the gas-phase carbon dioxide purification process, to remove impurities from high-pressure gas-phase carbon dioxide includes:
performing, by using multiple different purification components in a same purification device, the gas-phase carbon dioxide purification process to remove multiple types of the impurities; where the multiple different purification components are configured to purify different types of the impurities;
performing, by using multiple different purification devices arranged along a flow pipeline of the gas-phase carbon dioxide, the gas-phase carbon dioxide purification process to remove multiple types of the impurities; where the multiple different purification devices are configured to purify different types of the impurities; or
performing, by using multiple same purification devices arranged along the flow pipeline of the gas-phase carbon dioxide, the gas-phase carbon dioxide purification process to remove multiple types of the impurities; where the multiple same purification devices are configured to purify same types of the impurities.

In some embodiments, the impurities include at least liquid impurities and solid impurities. The gas-phase carbon dioxide purification process includes at least a solid purification process and a liquid purification process. The performing, by using multiple different purification components in a same purification device, the gas-phase carbon dioxide purification process to remove multiple types of the impurities includes:
performing, by using a first purification component in the purification device, the solid purification process to remove the solid impurities; and performing, by using a second purification component in the purification device, the liquid purification process to remove the liquid impurities.

Alternatively, the performing, by using multiple different purification devices arranged along a flow pipeline of the gas-phase carbon dioxide, the gas-phase carbon dioxide purification process to remove multiple types of the impurities includes:
performing, by using one of the multiple different purification devices, the solid purification process to remove the solid impurities; and performing, by using another one of the multiple different purification devices, the liquid purification process to remove the liquid impurities.

In some embodiments, the liquid impurities include at least one of moisture and grease. The solid impurifies include at least one selected from the group consisting of metal rust powder, abrasive powder, environmental dust, inorganic powder, and metal powder.

In some embodiments, the energy storage and release method further includes a pre-purification process. After the vaporization stage and before the gas-phase carbon dioxide purification process, the pre-purification process is performed to remove particulate matters from the low-pressure gas-phase carbon dioxide. A particle size of each of the particulate matters is greater than that of each of the solid impurifies.

In some embodiments, the energy storage step includes a pressurization stage and the condensation stage sequentially set in that order. In the pressurization stage, the pre-purification process is performed on the low-pressure gas-phase carbon dioxide (i.e., gas-phase carbon dioxide stored in the gas storage member) to obtain pre-purified low-pressure gas-phase carbon dioxide. The pre-purified low-pressure gas-phase carbon dioxide is at least compressed to obtain high-pressure gas-phase carbon dioxide. The gas-phase carbon dioxide purification process is performed on the high-pressure gas-phase carbon dioxide to obtain purified high-pressure gas-phase carbon dioxide, and the purified high-pressure gas-phase carbon dioxide enters the condensation stage.

Beneficial effects of the carbon dioxide phase change energy storage and release method provided by the disclosure are as follows.

Compared to the related art, in the carbon dioxide phase change energy storage and release method provided by the disclosure, the condensation stage includes the liquid-phase carbon dioxide purification process; in the condensation stage, the purified high-pressure gas-phase carbon dioxide is converted into liquid-phase carbon dioxide by the first phase change converter, when the stored liquid level of the liquid-phase carbon dioxide reaches the set liquid level, the liquid-phase carbon dioxide purification process is performed to remove the impurity liquid from the liquid-phase carbon dioxide according to the liquid-phase carbon dioxide purification process. In this way, the impurity liquid in the liquid carbon dioxide can be purified in a targeted manner through the liquid-phase carbon dioxide purification process, thereby achieving precise impurity removal of precise objects, reducing and eliminating adverse effects of the impurity liquid on the liquefaction temperature change of the energy storage and release system and the corrosion of various equipment pipelines, and making the energy storage and release system more perfect and optimized.

Another objective of the disclosure is to provide a carbon dioxide phase change energy storage and release system, the energy storage and release system includes an energy storage sub-system, and the energy storage sub-system includes a condensation assembly. The condensation assembly includes a first phase change converter, a liquid storage member and a liquid-phase carbon dioxide purification assembly, and the first phase change converter and the liquid-phase carbon dioxide purification assembly are connected to the liquid storage member individually. The first phase change converter is configured to convert purified high-pressure gas-phase carbon dioxide into liquid-phase carbon dioxide. The liquid storage member is configured to store the liquid-phase carbon dioxide. The liquid-phase carbon dioxide purification assembly is configured to perform a liquid-phase carbon dioxide purification process when a stored liquid level of the liquid-phase carbon dioxide reaches a set liquid level to remove impurity liquid from the liquid-phase carbon dioxide according to the liquid-phase carbon dioxide purification process.

In some embodiments, the liquid-phase carbon dioxide purification assembly includes an impurity liquid discharge pipeline, a liquid level sensor, a temperature sensor, a valve and a controller. The temperature sensor and the valve are disposed on the impurity liquid discharge pipeline, and the liquid level sensor and the temperature sensor are signally connected to the controller. The liquid level sensor is configured to determine the stored liquid level of the liquid-phase carbon dioxide and generate liquid level determination information. The temperature sensor is configured to collect a temperature of the impurity liquid discharge pipeline in real-time. The controller is configured to control the valve to open according to the liquid level determination information, and control the valve to keep open or control the valve to close according to the temperature.

In some embodiments, the energy storage and release system further includes an energy release sub-system, and the energy release sub-system includes a vaporization assembly. The vaporization assembly includes a liquid-phase pipeline and a second phase change converter. The liquid storage member is connected to the second phase change converter through the liquid-phase pipeline, and the second phase change converter is configured to convert the liquid-phase carbon dioxide into the low-pressure gas-phase carbon dioxide. The energy storage and release system further includes a gas-phase carbon dioxide purifier, the gas-phase carbon dioxide purifier is disposed between the first phase change converter and the second phase change converter, and the gas-phase carbon dioxide purifier is configured to perform a gas-phase carbon dioxide purification process to remove impurifies from the high-pressure gas-phase carbon dioxide.

In some embodiments, the energy storage and release system further includes a pre-purification assembly. The pre-purification assembly is disposed between a gas storage member and the gas-phase carbon dioxide purifier. The gas storage member is connected to the vaporization assembly. The pre-purification assembly is configured to perform a pre-purification process to remove particulate matters from the low-pressure gas-phase carbon dioxide. A particle size of each of the particulate matters is greater than that of each of the solid impurifies.

In some embodiments, the energy storage sub-system includes a pressurization assembly and the condensation assembly sequentially disposed in that order. The pressurization assembly includes the gas storage member, a compressor, and a first heat exchanger sequentially connected in that order. The pre-purification assembly is connected between the gas storage member and the compressor, and the gas-phase carbon dioxide purifier is connected between the first heat exchanger and the first phase change converter.

In some embodiments, the pre-purification assembly includes a pre-purifier and a metal cotton board disposed in the pre-purifier. The pre-purifier defines a first gas inlet and a second gas outlet on opposite sides of the metal cotton board respectively, and the first gas inlet and the second gas outlet are connected to the gas storage member and the compressor respectively.

The beneficial effects of the carbon dioxide phase change energy storage and release system provided in the disclosure compared with the related art are consistent with the beneficial effects of the carbon dioxide phase change energy storage and release method provided in the disclosure compared with the related art, and will not be repeated here.

### BRIEF DESCRIPTION OF DRAWINGS

In order to more clearly illustrate technical solutions in embodiments of the disclosure, drawings required for use in the embodiments or description of the related art will be briefly introduced below. Apparently, the drawings described below are merely some of the embodiments of the disclosure. For those skilled in the art, other drawings can be obtained based on these drawings without paying any creative labor.

FIG. 1 illustrates a flowchart of a carbon dioxide phase change energy storage and release method according to an embodiment of the disclosure.

FIG. 2 illustrates a flowchart of a liquid-phase carbon dioxide purification process according to an embodiment of the disclosure.

FIG. 3 illustrates a flowchart of the liquid-phase carbon dioxide purification process according to an embodiment of the disclosure.

FIG. 4 illustrates a schematic diagram of a carbon dioxide phase change energy storage and release system according to an embodiment of the disclosure.

FIG. 5 illustrates a schematic diagram of a condensation assembly according to an embodiment of the disclosure.

FIG. 6 illustrates a schematic diagram of a pre-purification assembly according to an embodiment of the disclosure.

FIG. 7 illustrates a schematic longitudinal sectional diagram of the pre-purification assembly according to an embodiment of the disclosure.

### DESCRIPTION OF REFERENCE SIGNS

101—gas storage member; 1020—pre-purification assembly; 103—compressor; 104—first heat exchanger; 105—gas-phase carbon dioxide purifier; 106—first phase change converter; 107—liquid storage member; 108—liquid-phase carbon dioxide purification assembly; 109—second phase change converter; 1010—second heat exchanger; 1011—heat storage container; 1012—turbine; 1013—liquid-phase pipeline;
1081—impurity liquid discharge pipeline; 1082—liquid level sensor; 1083—temperature sensor; 1084—valve; 1085—controller;
1021—pre-purifier; 1022—metal cotton board; 1021a—first gas inlet; 1021b—second gas outlet.

### DETAILED DESCRIPTION OF EMBODIMENTS

In order to make technical problems to be solved, technical solutions and beneficial effects of the disclosure more clearly understood, the disclosure is further described in detail below in conjunction with drawings and embodiments. It should be understood that the specific embodiments described herein are only used to explain the disclosure and are not used to limit the disclosure.

It should be noted that when an element is referred to as being “fixed to” or “disposed on” another element, it can be directly on the other element or indirectly on the other element. When an element is referred to as being “connected to” another element, it can be directly connected to the other element or indirectly connected to the other element.

It should be understood that an orientation or position relationship indicated by terms such as “length”, “width”, “up”, “down”, “front”, “back”, “left”, “right”, “vertical”, “horizontal”, “top”, “bottom”, “inside” and “outside” are based on the orientation or position relationship shown in the drawings, and are only for the convenience of describing the disclosure and simplifying the description, and do not indicate or imply that the device or element referred to must have a specific orientation, be constructed and operated in a specific orientation, and therefore should not be understood as a limitation on the disclosure.

In addition, terms “first” and “second” are used for descriptive purposes only and should not be understood as indicating or implying relative importance or implicitly indicating the number of the indicated technical features. Thus, a feature defined as “first” or “second” may explicitly or implicitly include one or more of the features. In the description of this disclosure, the meaning of “plurality”is two or more, unless otherwise clearly and specifically defined.

Carbon dioxide phase change energy storage and release method and system provided in the embodiments of the disclosure are described now.

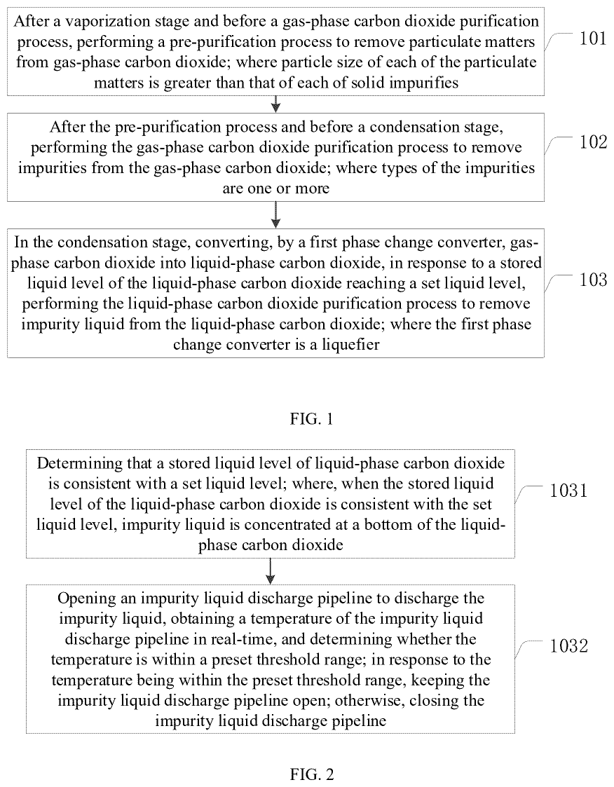

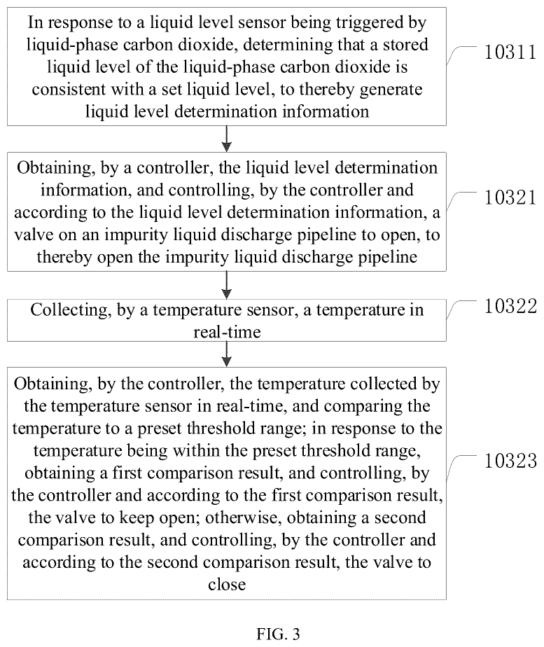

Referring to FIG. 1 to FIG. 3, the carbon dioxide phase change energy storage and release method provided in the embodiments of the disclosure includes an energy storage step and an energy release step. The energy storage step can include a pressurization stage and a condensation stage, and the energy release step can include a vaporization stage and a work pressure reduction stage.

The condensation stage includes a liquid-phase carbon dioxide purification process.

In step 103, in the condensation stage, high-pressure gas-phase carbon dioxide (i.e., purified high-pressure gas-phase carbon dioxide) is converted into liquid-phase carbon dioxide by a first phase change converter 106, when a stored liquid level of the liquid-phase carbon dioxide reaches a set liquid level, the liquid-phase carbon dioxide purification process is performed to remove impurity liquid from the liquid-phase carbon dioxide according to the liquid-phase carbon dioxide purification process. Specifically, the first phase change converter 106 can be a liquefier.

In this way, the impurity liquid in the liquid carbon dioxide can be purified in a targeted manner through the liquid-phase carbon dioxide purification process, thereby achieving precise impurity removal of precise objects, reducing and eliminating adverse effects of the impurity liquid on the liquefaction temperature change of the energy storage and release system and the corrosion of various equipment pipelines, and making the energy storage and release system more perfect and optimized.

In some embodiments, the liquid-phase carbon dioxide purification process includes the following steps 1031 to 1032.

In step 1031, the stored liquid level of the liquid-phase carbon dioxide is determined to be consistent with the set liquid level. When the stored liquid level of the liquid-phase carbon dioxide is consistent with the set liquid level, the impurity liquid is concentrated at a bottom of the liquid-phase carbon dioxide.

In step 1032, an impurity liquid discharge pipeline 1081 is opened to discharge the impurity liquid, a temperature of the impurity liquid discharge pipeline 1081 is obtained in real-time, and whether the temperature is within a preset threshold range is determined. In response to the temperature being within the preset threshold range, the impurity liquid discharge pipeline 1081 is kept open; otherwise, the impurity liquid discharge pipeline 1081 is closed.

In some embodiments, the above step 1031 further includes the following step 10311.

In step 10311, the stored liquid level of the liquid-phase carbon dioxide is determined to be consistent with the set liquid level in response to a liquid level sensor 1082 being triggered by the liquid-phase carbon dioxide, to thereby generate liquid level determination information.

The above step 1032 includes the following step 10321.

In step 10321, the liquid level determination information is obtained by a controller 1085, a valve on the impurity liquid discharge pipeline 1081 is controlled to open by the controller and according to the liquid level determination information, to thereby open the impurity liquid discharge pipeline 1081.

The embodiment cleverly utilizes the liquid level sensor 1082 to be triggered by the liquid-phase carbon dioxide to determine the consistency between the stored liquid level of the liquid-phase carbon dioxide and the set liquid level, and uses this as a start signal for the liquid-phase carbon dioxide purification process. When the impurity liquid happens to be concentrated at the bottom of the liquid-phase carbon dioxide, the liquid-phase carbon dioxide purification process is started, and the impurity liquid is purified at the best time, thereby improving the intelligence and timeliness of the liquid-phase carbon dioxide purification.

Specifically, the liquid-phase carbon dioxide can be stored in a liquid storage member 107. The liquid level sensor 1082 can be disposed on an inner wall of the liquid storage member 107. Alternatively, the liquid-phase carbon dioxide can be introduced out through a pipeline, and the liquid level sensor 1082 is disposed on the pipeline. The valve 1084 can be a program-controlled valve.

In some specific embodiments, the step 1032 further includes the following steps 10322 to 10323.

In step 10322, a temperature sensor 1083 is used to collect the temperature in real-time.

In step 10323, the controller 1085 is used to obtain the temperature collected by the temperature sensor 1083 in real-time, and compare the temperature to the preset threshold range. In response to the temperature being within the preset threshold range, a first comparison result is obtained, and the controller 1085 controls the valve 1084 to keep open according to the first comparison result; otherwise, a second comparison result is obtained, and the controller 1085 controls the valve 1084 to close according to the second comparison result.

In general, when high-pressure liquid-phase carbon dioxide is discharged from the liquid storage member 107, due to a cooling effect caused by the pressure reduction and throttling, that is, the high-pressure liquid-phase carbon dioxide flows into the impurity liquid discharge pipeline 1081, thus the temperature collected in real-time by the temperature sensor 1083 becomes smaller. At this time, the temperature is lower than a minimum of the preset threshold range, thus the second comparison result is obtained after comparison.

The embodiment cleverly utilizes a temperature difference formed after the impurity liquid and the high-pressure liquid-phase carbon dioxide flow into the impurity liquid discharge pipeline 1081 and the pressure reduction and throttling occur. The temperature difference is used to identify the contents currently flowing through the impurity liquid discharge pipeline 1081, and then the identification result is obtained by comparing the temperatures, and the valve 1084 is opened or closed accordingly to achieve purification of the impurity liquid.

In some embodiments, the impurity liquid at least includes water liquid, and the water liquid includes at least one of free water and dissolved water. Certainly, the impurity liquid can also include other non-aqueous impurity liquids, such as grease.

In some embodiments, the energy storage and release method further includes a gas-phase carbon dioxide purification process. In the vaporization stage, the liquid-phase carbon dioxide obtained through the liquid-phase carbon dioxide purification process is converted into the gas-phase carbon dioxide (i.e., low-pressure gas-phase carbon dioxide) by a second phase change converter 109. After the vaporization stage and before the condensation stage, the gas-phase carbon dioxide purification process is performed to remove impurities from the gas-phase carbon dioxide (i.e., high-pressure gas-phase carbon dioxide), and types of the impurities are one or more.

In an exemplary embodiment, the energy storage and release method can include the following step 102.

In step 102, after the pre-purification process and before the condensation stage, the gas-phase carbon dioxide purification process is performed to remove the impurities from the gas-phase carbon dioxide (i.e., high-pressure gas-phase carbon dioxide), and types of the impurities are one or more.

In this way, based on the purification of the liquid-phase carbon dioxide, the gas-phase carbon dioxide (i.e., high-pressure gas-phase carbon dioxide) can be purified through the gas-phase carbon dioxide purification process, that is, carbon dioxide can be purified specifically when it is in the gas-phase and liquid-phase respectively, rather than just in a single phase, thereby achieving comprehensive and high-precision separation and discharge of impurities, reducing and eliminating the adverse effects of impurities on the liquefaction of carbon dioxide working fluid, the corrosion resistance of equipment and pipelines of the energy storage and release system, and weakening and eliminating the wear effect on mechanical kinetic energy equipment, making the energy storage and release system more perfect and optimized.

In some embodiments, the types of the impurities are more. The after the vaporization stage and before the condensation stage, the gas-phase carbon dioxide purification process is performed to remove impurities from the gas-phase carbon dioxide includes the following steps.

Multiple different purification components in a same purification device are used to perform the gas-phase carbon dioxide purification process to remove multiple types of the impurities. The multiple different purification components are configured to purify different types of the impurities.

Alternatively, multiple different purification devices arranged along a flow pipeline of the gas-phase carbon dioxide are used to perform the gas-phase carbon dioxide purification process to remove multiple types of the impurities. The multiple different purification devices are configured to purify different types of the impurities.

Alternatively, multiple same purification devices arranged along the flow pipeline of the gas-phase carbon dioxide are used to perform the gas-phase carbon dioxide purification process to remove multiple types of the impurities. The multiple same purification devices are configured to purify same types of the impurities.

In some specific embodiments, the impurities include at least liquid impurities and solid impurities. The gas-phase carbon dioxide purification process includes at least a solid purification process and a liquid purification process.

Specifically, the multiple different purification components in the same purification device are used to perform the gas-phase carbon dioxide purification process to remove multiple types of the impurities through the following steps.

A first purification component in the purification device is used to perform the solid purification process to remove the solid impurities, and a second purification component in the purification device is used to perform the liquid purification process to remove the liquid impurities.

Alternatively, the multiple different purification devices arranged along a flow pipeline of the gas-phase carbon dioxide are used to perform the gas-phase carbon dioxide purification process to remove multiple types of the impurities through the following steps.

One of the multiple different purification devices is used to perform the solid purification process to remove the solid impurities, and another one of the multiple different purification devices is used to perform the liquid purification process to remove the liquid impurities.

In some embodiments, the liquid impurities include at least one of moisture and grease. The solid impurifies include at least one selected from the group consisting of metal rust powder, abrasive powder, environmental dust, inorganic powder, and metal powder.

In an exemplary embodiment, after the vaporization stage, specifically, after the gas storage member and before the condensation stage, the energy storage and release system is provided with multiple gas-phase pipe sections. In the scheme that using multiple different purification components in the same purification device to perform the gas-phase carbon dioxide purification process to remove multiple types of the impurities, at least one of the multiple gas-phase pipe sections can be provided with one purification device or multiple purification devices. For example, a gas-phase pipe section is provided with a purification device, a gas-phase pipe section is provided with multiple purification devices, or different gas-phase pipe sections are provided with multiple purification devices one to one.

In the scheme that using the multiple different purification devices arranged along the flow pipeline of the gas-phase carbon dioxide to perform the gas-phase carbon dioxide purification process to remove multiple types of the impurities, at least part of the multiple gas-phase pipe sections can be provided with multiple different purification devices. For example, a gas-phase pipe section is provided with the multiple different purification devices, or multiple different gas-phase pipe sections are provided with the multiple different purification devices one to one.

In the scheme that using multiple same purification devices arranged along the flow pipeline of the gas-phase carbon dioxide to perform the gas-phase carbon dioxide purification process to remove multiple types of the impurities, one of the multiple gas-phase pipe sections can be provided with one or more of the purification devices. For example, a gas-phase pipe section is provided with the multiple same purification devices, or multiple different gas-phase pipe sections are provided with the multiple same purification devices one to one.

In some embodiments, the energy storage and release method further includes a pre-purification process. After the vaporization stage and before the gas-phase carbon dioxide purification process, the pre-purification process is performed to remove particulate matters from the gas-phase carbon dioxide (i.e., low-pressure gas-phase carbon dioxide). A particle size of each of the particulate matters is greater than that of each of the solid impurifies.

Specifically, the pre-purification process can purify and remove particulate matters larger than 20 microns (μm) in size.

In some embodiments, the energy storage step includes a pressurization stage and the condensation stage sequentially set in that order. In the pressurization stage, the pre-purification process is performed on the low-pressure gas-phase carbon dioxide to obtain pre-purified low-pressure gas-phase carbon dioxide. The pre-purified low-pressure gas-phase carbon dioxide is at least compressed to obtain high-pressure gas-phase carbon dioxide. The gas-phase carbon dioxide purification process is performed on the high-pressure gas-phase carbon dioxide to obtain purified high-pressure gas-phase carbon dioxide, and the purified high-pressure gas-phase carbon dioxide enters the condensation stage.

Specifically, the pre-purification process is performed on the low-pressure gas-phase carbon dioxide to obtain the pre-purified low-pressure gas-phase carbon dioxide. The pre-purified low-pressure gas-phase carbon dioxide can be compressed to obtain the high-pressure gas-phase carbon dioxide. The high-pressure gas-phase carbon dioxide passes through the first heat exchanger 104 to obtain low-temperature and high-pressure gas-phase carbon dioxide. The gas-phase carbon dioxide purification process is performed on the low-temperature and high-pressure gas-phase carbon dioxide to obtain the purified high-pressure gas-phase carbon dioxide, and the purified high-pressure gas-phase carbon dioxide enters the condensation stage.

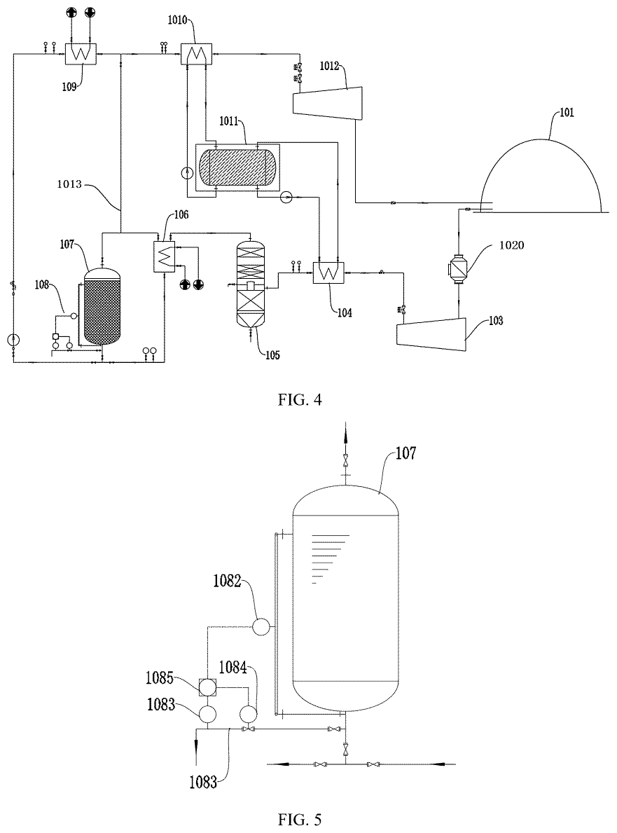

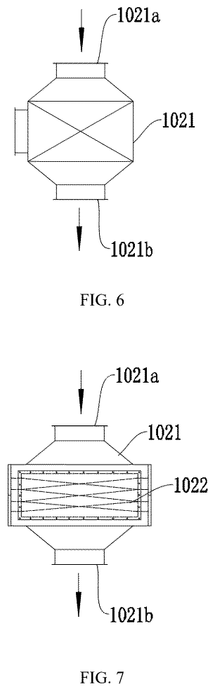

Referring to FIG. 4 to FIG. 7, another objective of the embodiments of the disclosure is to provide a carbon dioxide phase change energy storage and release system, the energy storage and release system includes an energy storage sub-system, and the energy storage sub-system includes a condensation assembly. The condensation assembly includes a first phase change converter 106, a liquid storage member 107 and a liquid-phase carbon dioxide purification assembly 108, and the first phase change converter 106 and the liquid-phase carbon dioxide purification assembly 108 are connected to the liquid storage member 107 individually.

Specifically, the first phase change converter 106 is configured to convert gas-phase carbon dioxide (i.e., purified high-pressure gas-phase carbon dioxide) into liquid-phase carbon dioxide. The liquid storage member 107 is configured to store the liquid-phase carbon dioxide. The liquid-phase carbon dioxide purification assembly 108 is configured to perform a liquid-phase carbon dioxide purification process when a stored liquid level of the liquid-phase carbon dioxide reaches a set liquid level, to remove impurity liquid from the liquid-phase carbon dioxide according to the liquid-phase carbon dioxide purification process.

In some embodiments, the liquid-phase carbon dioxide purification assembly 108 includes an impurity liquid discharge pipeline 1081, a liquid level sensor 1082, a temperature sensor 1083, a valve 1084 and a controller 1085. The temperature sensor 1083 and the valve 1084 are disposed on the impurity liquid discharge pipeline 1081, and the liquid level sensor 1082 and the temperature sensor 1083 are signally connected to the controller 1085 individually.

The liquid level sensor 1082 is configured to determine the stored liquid level of the liquid-phase carbon dioxide and generate liquid level determination information. The temperature sensor 1083 is configured to collect a temperature of the impurity liquid discharge pipeline 1081 in real-time. The controller 1085 is configured to control the valve 1084 to open according to the liquid level determination information, and control the valve 1084 to keep open or control the valve to close according to the temperature.

In some embodiments, the energy storage and release system further includes an energy release sub-system, and the energy release sub-system includes a vaporization assembly. The vaporization assembly includes a liquid-phase pipeline 1013 and a second phase change converter 109. The liquid storage member 107 is connected to the second phase change converter 109 through the liquid-phase pipeline 1013, and the second phase change converter 109 is configured to convert the liquid-phase carbon dioxide into the gas-phase carbon dioxide (i.e., low-pressure gas-phase carbon dioxide). The energy storage and release system further includes a gas-phase carbon dioxide purifier 105, the gas-phase carbon dioxide purifier 105 is disposed between the first phase change converter 106 and the second phase change converter 109, and the gas-phase carbon dioxide purifier 105 is configured to perform a gas-phase carbon dioxide purification process to remove impurifies from the gas-phase carbon dioxide.

In some embodiments, the energy storage and release system further includes a pre-purification assembly 1020. The pre-purification assembly 1020 is disposed between a gas storage member 101 and the gas-phase carbon dioxide purifier 105. The gas storage member 101 is connected to the vaporization assembly. The pre-purification assembly 1020 is configured to perform a pre-purification process to remove particulate matters from the gas-phase carbon dioxide. A particle size of each of the particulate matters is greater than that of each of the solid impurifies.

In some embodiments, the energy storage sub-system includes a pressurization assembly and the condensation assembly sequentially disposed in that order. The pressurization assembly includes the gas storage member 101, the pre-purification assembly 1020, a compressor 103, and a first heat exchanger 104 sequentially connected in that order, and the gas-phase carbon dioxide purifier 105 is connected between the first heat exchanger 104 and the first phase change converter 106.

In some embodiments, the pre-purification assembly 1020 includes a pre-purifier 1021 and a metal cotton board 1022 disposed in the pre-purifier 1021. The pre-purifier 1021 defines a first gas inlet 1021a and a second gas outlet 1021b on opposite sides of the metal cotton board 1022 respectively, and the first gas inlet 1021a and the second gas outlet 1021b are connected to the gas storage member 101 and the compressor 103 respectively.

In some specific embodiments, the energy storage and release system includes the gas storage member 101, the compressor 103, the first heat exchanger 104, the first phase change converter 106, the liquid storage member 107, the second phase change converter 109, a second heat exchanger 1010, a heat storage container 1011 and a turbine 1012. Specifically, the gas storage member 101, the compressor 103, the first heat exchanger 104, the first phase change converter 106, and the liquid storage member 107 are sequentially connected in that order, and the second phase change converter 109, the second heat exchanger 1010, the turbine 1012 and the gas storage member 101 are sequentially connected in that order. The heat storage container 1011 is connected between the first heat exchanger 104 and the second heat exchanger 1010. The liquid storage member 107 is connected between the first phase change converter 106 and the second phase change converter 109. The gas-phase carbon dioxide purifier 105 is disposed on a gas-phase pipe section between the first heat exchanger 104 and the liquefier (i.e., the first phase change converter 106), the gas-phase carbon dioxide purifier 105 is disposed on a gas-phase pipe section between the second phase change converter 109 and the second heat exchanger 1010; or the gas-phase carbon dioxide purifier 105 is disposed on a gas-phase pipe section between the second heat exchanger 1010 and the turbine 1012.

In the energy storage stage of the system, the low-pressure carbon dioxide gas in the gas storage member 101 is purified by the pre-purification assembly 1020, then compressed by the compressor 103 to high-pressure carbon dioxide gas. The high-pressure carbon dioxide gas is cooled by the first heat exchanger 104 under a situation that the pressure remains unchanged, and the cooled high-pressure carbon dioxide gas enters the gas-phase carbon dioxide purifier 105. In some embodiments, a temperature T of the high-pressure carbon dioxide gas entering the gas-phase carbon dioxide purifier 105 is controlled to be less than 80 Celsius degrees (° C.) , a resistance reduction of the high-pressure carbon dioxide gas entering the gas-phase carbon dioxide purifier 105 is controlled to be less than 30 kilopascals (kPa), so as to form temperature and pressure protection for the hardware facilities of the gas-liquid-solid separation device. The purified high-pressure carbon dioxide gas enters the first phase change converter for phase change, condensation and liquefaction, and the liquefied liquid-phase carbon dioxide enters the liquid storage member 107 for storage, thereby completing the energy storage operation process of the carbon dioxide phase change energy storage and release system.

In the energy release stage of the system, liquid in the liquid storage member 107 is purified by the liquid-phase carbon dioxide purification assembly 108, the carbon dioxide is pumped to the second phase change converter 109. The liquid-phase carbon dioxide is vaporized to carbon dioxide gas, the carbon dioxide gas is heated through the second heat exchanger 1010 to raise the temperature to a rated temperature of the system, and then the heated carbon dioxide gas enters the turbine 1012 to expand and perform work. The turbine 1012 drives a generator to generate electricity. The low-temperature and low-pressure carbon dioxide gas after the turbine expansion and work returns to the gas storage member 101 for low-pressure storage, thus completing the energy release process of the carbon dioxide phase change energy storage and release system.

The beneficial effects of the carbon dioxide phase change energy storage and release system provided in the disclosure compared with the related art are consistent with the beneficial effects of the carbon dioxide phase change energy storage and release method provided in the disclosure compared with the related art, and will not be repeated here. The above description is merely some of the embodiments of the disclosure and is not intended to limit the disclosure. Any modifications, equivalent substitutions and improvements made within the spirit and principles of the disclosure shall be included in the protection scope of the disclosure.

What is claimed is:

1. A carbon dioxide phase change energy storage and release method, comprising an energy storage step, wherein the energy storage step comprises a condensation stage; and the condensation stage comprises a liquid-phase carbon dioxide purification process;
wherein the condensation stage comprises:
converting, by a first phase change converter, gas-phase carbon dioxide into liquid-phase carbon dioxide;
in response to a stored liquid level of the liquid-phase carbon dioxide reaching a set liquid level, performing the liquid-phase carbon dioxide purification process to remove impurity liquid from the liquid-phase carbon dioxide; and
wherein the liquid-phase carbon dioxide purification process comprises:
determining that the stored liquid level of the liquid-phase carbon dioxide is consistent with the set liquid level; wherein, when the stored liquid level of the liquid-phase carbon dioxide is consistent with the set liquid level, the impurity liquid is concentrated at a bottom of the liquid-phase carbon dioxide;
opening an impurity liquid discharge pipeline to discharge the impurity liquid, obtaining a temperature of the impurity liquid discharge pipeline in real-time, and determining whether the temperature is within a preset threshold range; and
in response to the temperature being within the preset threshold range, keeping the impurity liquid discharge pipeline open; otherwise, closing the impurity liquid discharge pipeline.

2. The carbon dioxide phase change energy storage and release method as claimed in claim 1, wherein the determining that the stored liquid level of the liquid-phase carbon dioxide is consistent with the set liquid level comprises:
in response to a liquid level sensor being triggered by the liquid-phase carbon dioxide, determining that the stored liquid level of the liquid-phase carbon dioxide is consistent with the set liquid level, to thereby generate liquid level determination information; and
wherein the opening an impurity liquid discharge pipeline to discharge the impurity liquid comprises:
obtaining, by a controller, the liquid level determination information, and controlling, by the controller and according to the liquid level determination information, a valve on the impurity liquid discharge pipeline to open, to thereby open the impurity liquid discharge pipeline.

3. The carbon dioxide phase change energy storage and release method as claimed in claim 2, wherein the obtaining a temperature of the impurity liquid discharge pipeline in real-time, and determining whether the temperature is within a preset threshold range comprises:
collecting, by a temperature sensor, the temperature in real-time;
obtaining, by the controller, the temperature collected by the temperature sensor in real-time, and comparing the temperature to the preset threshold range; and
in response to the temperature being within the preset threshold range, obtaining a first comparison result, and controlling, by the controller and according to the first comparison result, the valve to keep open; otherwise, obtaining a second comparison result, and controlling, by the controller and according to the second comparison result, the valve to close.

4. The carbon dioxide phase change energy storage and release method as claimed in claim 1, wherein the impurity liquid at least comprises water liquid, and the water liquid comprises at least one of free water and dissolved water.

5. The carbon dioxide phase change energy storage and release method as claimed in claim 1, further comprising an energy release step, wherein the energy release step comprises a vaporization stage; and the carbon dioxide phase change energy storage and release method further comprises a gas-phase carbon dioxide purification process;
wherein the carbon dioxide phase change energy storage and release method comprises:
in the vaporization stage, converting, by a second phase change converter, the liquid-phase carbon dioxide obtained through the liquid-phase carbon dioxide purification process into gas-phase carbon dioxide; and
after the vaporization stage and before the condensation stage, performing the gas-phase carbon dioxide purification process, to remove impurities from the gas-phase carbon dioxide; wherein types of the impurities are one or more.

6. The carbon dioxide phase change energy storage and release method as claimed in claim 5, wherein the types of the impurities are more;
wherein the after the vaporization stage and before the condensation stage, performing the gas-phase carbon dioxide purification process, to remove impurities from the gas-phase carbon dioxide comprises:
performing, by using a plurality of different purification components in a same purification device, the gas-phase carbon dioxide purification process to remove a plurality of types of the impurities; wherein the plurality of different purification components are configured to purify different types of the impurities; or
performing, by using a plurality of different purification devices arranged along a flow pipeline of the gas-phase carbon dioxide, the gas-phase carbon dioxide purification process to remove a plurality of types of the impurities; wherein the plurality of different purification devices are configured to purify different types of the impurities; or
performing, by using a plurality of same purification devices arranged along the flow pipeline of the gas-phase carbon dioxide, the gas-phase carbon dioxide purification process to remove a plurality of types of the impurities; wherein the plurality of same purification devices are configured to purify same types of the impurities.

7. The carbon dioxide phase change energy storage and release method as claimed in claim 6, wherein the impurities comprise at least liquid impurities and solid impurities;
wherein the gas-phase carbon dioxide purification process comprises at least a solid purification process and a liquid purification process;
wherein the performing, by using a plurality of different purification components in a same purification device, the gas-phase carbon dioxide purification process to remove a plurality of types of the impurities comprises:
performing, by using a first purification component in the purification device, the solid purification process to remove the solid impurities; and performing, by using a second purification component in the purification device, the liquid purification process to remove the liquid impurities; or
wherein the performing, by using a plurality of different purification devices arranged along a flow pipeline of the gas-phase carbon dioxide, the gas-phase carbon dioxide purification process to remove a plurality of types of the impurities comprises:
performing, by using one of the plurality of different purification devices, the solid purification process to remove the solid impurities; and performing, by using another one of the plurality of different purification devices, the liquid purification process to remove the liquid impurities.

8. The carbon dioxide phase change energy storage and release method as claimed in claim 7, wherein the liquid impurities comprise at least one of moisture and grease; and
wherein the solid impurifies comprise at least one selected from the group consisting of metal rust powder, abrasive powder, environmental dust, inorganic powder, and metal powder.

9. The carbon dioxide phase change energy storage and release method as claimed in claim 5, further comprising a pre-purification process;
wherein the carbon dioxide phase change energy storage and release method comprises:
after the vaporization stage and before the gas-phase carbon dioxide purification process, performing the pre-purification process to remove particulate matters from the gas-phase carbon dioxide; wherein a particle size of each of the particulate matters is greater than that of each of the solid impurifies.

10. The carbon dioxide phase change energy storage and release method as claimed in claim 9, wherein the energy storage step comprises a pressurization stage and the condensation stage sequentially set in that order; and the carbon dioxide phase change energy storage and release method comprises:
in the pressurization stage, performing the pre-purification process on low-pressure gas-phase carbon dioxide to obtain pre-purified low-pressure gas-phase carbon dioxide, at least compressing the pre-purified low-pressure gas-phase carbon dioxide to obtain high-pressure gas-phase carbon dioxide, performing the gas-phase carbon dioxide purification process on the high-pressure gas-phase carbon dioxide to obtain purified high-pressure gas-phase carbon dioxide, wherein the purified high-pressure gas-phase carbon dioxide enters the condensation stage.

11. A carbon dioxide phase change energy storage and release system, comprising an energy storage sub-system, wherein the energy storage sub-system comprises a condensation assembly;
wherein the condensation assembly comprises a first phase change converter, a liquid storage member and a liquid-phase carbon dioxide purification assembly, and the first phase change converter and the liquid-phase carbon dioxide purification assembly are connected to the liquid storage member individually;
wherein the first phase change converter is configured to convert gas-phase carbon dioxide into liquid-phase carbon dioxide, the liquid storage member is configured to store the liquid-phase carbon dioxide, and the liquid-phase carbon dioxide purification assembly is configured to: in response to a stored liquid level of the liquid-phase carbon dioxide reaching a set liquid level, perform a liquid-phase carbon dioxide purification process to remove impurity liquid from the liquid-phase carbon dioxide;
wherein the liquid-phase carbon dioxide purification assembly comprises an impurity liquid discharge pipeline, a liquid level sensor, a temperature sensor, a valve and a controller; and the temperature sensor and the valve are disposed on the impurity liquid discharge pipeline, and the liquid level sensor and the temperature sensor are signally connected to the controller; and
wherein the liquid level sensor is configured to determine the stored liquid level of the liquid-phase carbon dioxide and generate liquid level determination information, the temperature sensor is configured to collect a temperature of the impurity liquid discharge pipeline in real-time, and the controller is configured to control the valve to open according to the liquid level determination information, and control the valve to keep open or control the valve to close according to the temperature.

12. The carbon dioxide phase change energy storage and release system as claimed in claim 11, further comprising an energy release sub-system, wherein the energy release sub-system comprises a vaporization assembly;
wherein the vaporization assembly comprises a liquid-phase pipeline and a second phase change converter, the liquid storage member is connected to the second phase change converter through the liquid-phase pipeline, and the second phase change converter is configured to convert the liquid-phase carbon dioxide into gas-phase carbon dioxide; and
wherein the energy storage and release system further comprises a gas-phase carbon dioxide purifier, the gas-phase carbon dioxide purifier is disposed between the first phase change converter and the second phase change converter, and the gas-phase carbon dioxide purifier is configured to perform a gas-phase carbon dioxide purification process to remove impurifies from the gas-phase carbon dioxide.

13. The carbon dioxide phase change energy storage and release system as claimed in claim 12, further comprising a pre-purification assembly, wherein the pre-purification assembly is disposed between a gas storage member and the gas-phase carbon dioxide purifier, the gas storage member is connected to the vaporization assembly, and the pre-purification assembly is configured to perform a pre-purification process to remove particulate matters from the gas-phase carbon dioxide; and a particle size of each of the particulate matters is greater than that of each of solid impurifies.

14. The carbon dioxide phase change energy storage and release system as claimed in claim 13, wherein the energy storage sub-system comprises a pressurization assembly and the condensation assembly sequentially disposed in that order; and
wherein the pressurization assembly comprises the gas storage member, a compressor, and a first heat exchanger sequentially connected in that order, the pre-purification assembly is connected between the gas storage member and the compressor, and the gas-phase carbon dioxide purifier is connected between the first heat exchanger and the first phase change converter.

15. The carbon dioxide phase change energy storage and release system as claimed in claim 14, wherein the pre-purification assembly comprises a pre-purifier and a metal cotton board disposed in the pre-purifier; and
wherein the pre-purifier defines a first gas inlet and a second gas outlet on opposite sides of the metal cotton board respectively, and the first gas inlet and the second gas outlet are connected to the gas storage member and the compressor respectively.
